(19) United States
(12) Patent Application Publication
(10) Pub. No.: US 2020/0087973 A1
(43) Pub. Date: Mar. 19, 2020

(54) DOOR MOVING DEVICE, DOOR SYSTEM COMPRISING A DOOR AND A DOOR MOVING DEVICE, AND METHOD FOR MOVING A DOOR

(71) Applicant: ZF Friedrichshafen. AG, Friedrichshafen (DE)

(72) Inventors: Rainer Haevescher, Stemwede (DE); Artur Neumann, Kalletal (DE); Jörg Grotendorst, Nürnberg (DE)

(73) Assignee: ZF Friedrichshafen. AG, Friedrichshafen (DE)

(21) Appl. No.: 16/618,850

(22) PCT Filed: May 8, 2018
(86) PCT No.: PCT/EP2018/061743

§ 371 Date: Dec. 3, 2019

(30) Foreign Application Priority Data
Jun. 7, 2017 (DE) 10 2017 209 526.1

(51) Int. Cl. E05F 15/70; E05F 5/00; E05F 15/614

(52) U.S. Cl. CPC E05F 15/70; E05F 5/00; E05F 15/614; E05Y 2900/531; E05Y 2400/21; E05Y 2201/408; E05Y 2201/21; E05Y 2400/302

(57) ABSTRACT

The present approach relates to a door moving device (110). The door moving device (115) comprises at least a force providing device (200), a drive device (205), and a brake device (210). The force providing device (200) is configured to provide the force for controlling a movement of the door (110). The drive device (205) is configured to generate a drive torque for driving the force providing device (200). The brake device (210) can be actuated electrically, and is configured to generate a braking torque when not provided with electricity for braking the force providing device (200) for the door (110).

The present approach relates to a door moving device for a door, a door system that has a door and a door moving device, and a method for moving a door.

Vehicle doors typically have defined catches that ensure that the door remains stationary at certain opening. Alternatively, the doors in some vehicles are controlled with actuators, in order to increase the convenience of operating them. Hydraulic door operators or purely motorized door operators can be used for this.

Based on the above, the present approach results in an improved door moving device for a door, a door system that has an improved door moving device, and an improved method for moving a door according to the independent claims. Advantageous embodiments can be derived from the dependent claims and the following description.

The door moving device presented herein advantageously enables a movement, braking, and retention of a door with low energy consumption and space requirements.

A door moving device for a door comprises at least one force providing device, a drive device, and a brake device. The force providing device is configured to provide a force for controlling the movement of the door. The drive device is configured to generate a drive torque for driving the force providing device. The drive device can contain, e.g., an electric drive such as an electric motor for this. The drive device can be configured to generate a drive torque necessary for enabling an opening and/or closing of the door. The brake device can be actuated electrically, and is configured to generate a braking torque for braking the force providing device of the door when not supplied with electricity.

A segment or element of the force providing device can be configured as an interface for applying the force to the door. The force for controlling the movement of the door, from the door moving device in the installed state, can be used via the interface to close or open the door. The force providing device can be braked or retained by the brake device strongly enough that an undesired movement of the door is prevented. In that the brake device can provide the braking torque when it is not supplied with electricity, the door can be retained in an open position without electrical energy.

It is advantageous when the brake device comprises at least one magnetorheological material such as a magnetorheological elastomer, and an actuator for adjusting a viscoelastic property of the magnetorheological material. The brake device can thus be configured to generate a first braking torque when not supplied with electricity, e.g. for retaining or securing the door in place, and a second braking torque when it is supplied with electricity, which is lower than the first braking torque. As such, the door can be moved easily when the braking device is supplied with electricity, i.e. very little energy from the drive device is then necessary to move the door.

The door moving device can contain a regulating device that is configured to output a drive signal for controlling the drive device and/or a braking signal for controlling the brake device. The braking signal can be configured such that it is not supplied in the state when the brake device is not supplied with electricity, and to provide the necessary electricity for controlling the actuator when the brake device is supplied with electricity.

The force providing device can comprise at least one shaft, which is coupled to the brake device. Such a shaft is well suited for providing the force and coupling the devices. The shaft can be coupled at one end to a brake device, and to a gearwheel at the other end, in order to apply the force to the door, for example. The door moving device can also contain gear ratio device with at least one gear ratio element, wherein the gear ratio device also couples the drive device to the force providing device, thus the shaft. There can also be numerous gear ratio elements of the gear ratio device located between the drive device and the shaft. The gear ratio device can be located between the gearwheel and the brake device. As a result, both the braking torque and the drive torque can act on the shaft, in order to provide the force for controlling the movement of the door.

To mechanically couple the door moving device with the door, or to make this possible, it is advantageous if the force providing device comprises an element of a hinge, e.g. a hinge strap, for the door. The hinge strap can be located in the region of the gearwheel.

To make it possible to control the door based on environment parameters, the door moving device can comprise at least one environment sensor device, which is configured to detect an obstacle in the movement range or opening range of the door. The regulating device can then brake the movement of the door, or prevent an opening or closing of the door in response to a corresponding obstacle sensor signal that has been received. The environment sensor device can comprise at least a 2D camera and/or a 3D camera, and/or a light barrier device, and/or a 3D scanner.

The door moving device can also contain at least one sensor device that is configured to detect a closing angle and/or a torque in the movement or operation of the door. The regulating device can then automatically cause a closing of the door to a final latched position, for example, in response to a corresponding closing angle signal and/or torque signal, which can represent, e.g., a closed or nearly closed door.

A door system contains at least the door and any of the door movement devices presented herein. The door system presented herein can replace known door systems, wherein the door system presented herein advantageously obtains the advantages described above due to the door moving device. The force providing device of the door moving device is coupled to the door to open and close the door, e.g. connected mechanically thereto.

A method for moving a door comprises at least the following steps:

Generating a drive torque for driving a force providing device for providing a force for controlling the movement of the door; and

Generating a braking torque for braking the force providing device through the use of an electrically actuated brake device, when the brake device is not supplied with electricity.

The method can be executed using any of the door moving devices presented above. The advantages of the door moving device can also be obtained in a technically simple and inexpensive manner through such a method.

Exemplary embodiments of the approach presented herein are illustrated in the drawings, and explained in greater detail in the following description. Therein:

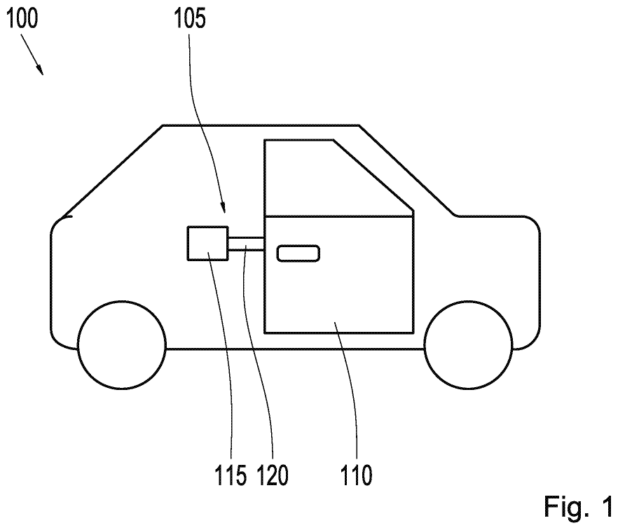

FIG. 1 shows a schematic side view of a vehicle that has a door system, a door, and a door moving device according to an exemplary embodiment;

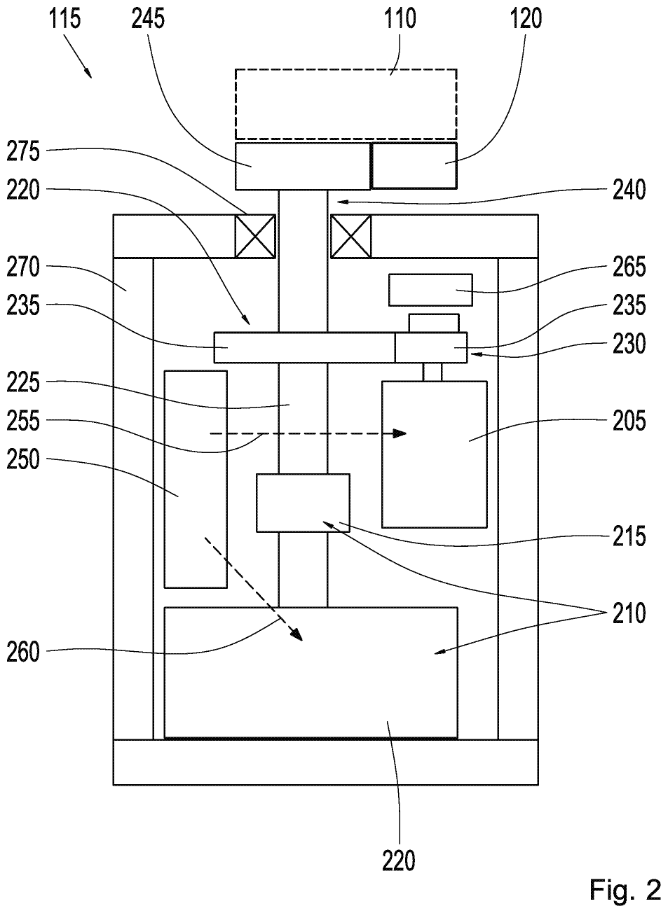

FIG. 2 shows a schematic illustration of a door moving device according to an exemplary embodiment; and

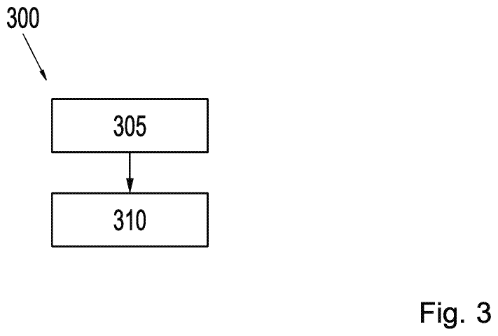

FIG. 3 shows a flow chart for a method for moving a door according to an exemplary embodiment.

In the following description of preferred exemplary embodiments of the present approach, identical or similar symbols are used for the elements illustrated in the figures that have similar functions, wherein there shall be no repetition of the descriptions of these elements.

FIG. 1 shows a schematic side view of a vehicle 100 that has a door system 105 comprising a door 110 and a door moving device 115 according to an exemplary embodiment. By way of example, the vehicle 100 is a passenger car.

The door 110 in this exemplary embodiment is a side door of the vehicle 100, and in another exemplary embodiment, the door 110 is the hatch or some other door of the vehicle 100. The door moving device 115 is located in the region of the door 110. According to this exemplary embodiment, the door 110 and the door moving device 115 are connected to one another by a hinge strap 120.

FIG. 2 shows a schematic illustration of a door moving device 115 according to an exemplary embodiment. This can be the door moving device 115 described in reference to FIG. 1.

The door moving device 115 has at least one force providing device 200, one drive device 205, and one brake device 210.

The force providing device 200 is configured to provide a force for controlling a movement of the door 110. For this, the force providing device 200 can be coupled to the door 110 in the installed state, such that the force can be applied to the door. The drive device 205 is configured to generate a drive torque for driving the force providing device 200. The brake device 210 can be actuated electrically, and is configured to generate a braking torque, at least when it is not supplied with electricity, for braking the force providing element 200. When it is not provided with electricity, the brake device 210 is not supplied with electrical energy, for example.

According to this exemplary embodiment, the brake device 210 comprises a least one magnetorheological material 215, e.g. an elastomer, and an actuator 220 for adjusting a viscoelastic property of the magnetorheological material 215. The force providing device 200 comprises at least one shaft 225 according to this exemplary embodiment, which is guided by the magnetorheological material 215, and braked to a greater or lesser extend, depending on the viscosity of the magnetorheological material 215. With a higher viscosity of the magnetorheological material 215, the friction is greater between the magnetorheological material 215 and the shaft 225. The brake device 220 is configured to generate a first braking torque when the actuator 220 is not supplied with electricity, and a second braking torque acting on the shaft 225 when the actuator is supplied with electricity. The second braking torque is lower than the first braking torque. According to one exemplary embodiment, the first braking torque is sufficient for preventing the door from moving by itself, e.g. due to gravity. The braking torque can be reduced by supplying the actuator 220 with electricity. This is useful, for example, when the door 110 is powered by the door moving device 115. According to one exemplary embodiment, the actuator 220 is configured to generate a magnetic field that acts on the magnetorheological material 215 in the active state, in which an electrical current flows through the actuator 220. The viscosity of the magnetorheological material 215 is affected by the magnetic field, such that it is reduced in this case, in order to reduce the braking effect acting on the shaft 225. According to one exemplary embodiment, the brake device 210 is located at one end of the shaft 225. If a magnetic field generated by the actuator 220 is not applied to the magnetorheological material 215, then the magnetorheological material 215 according to one exemplary embodiment has a high viscosity, which results in the aforementioned first braking torque.

The force providing device 200 comprises a gear ratio device 230 according to this exemplary embodiment, which in turn contains, e.g., two gear ratio elements 235, in this case gearwheels. The gear ratio device 230 couples the drive device 205, in this case an electric motor, to the force providing device 200. According to this exemplary embodiment, a torque from a shaft in the drive device 205 is applied to the shaft 225 via the gear ratio device 230.

The shaft 225 has, e.g., a gearwheel 245 at one end 240 of the shaft 225, for applying a force provided by the shaft 225 to the door 110. The hinge strap 120 shown in FIG. 1 is part of the door moving device 115 according to this exemplary embodiment, and coupled to the shaft 225 via the gearwheel 245. In this manner, a torque of the shaft 225 can be applied to the hinge strap 120, and thus the force for controlling the movement of the door 110 can be applied to the door 110. According to an alternative exemplary embodiment, the door moving device 115 comprises another element of a hinge or a hinge for the door 110 as an alternative or in addition to the hinge strap 120.

As an alternative to the shaft 225, the force providing device 200 can have some other type of element for transferring forces, e.g. a gear rack.

The door moving device 115 according to one exemplary embodiment contains a regulating device 250, e.g. in the form of a control unit, which is configured to output a drive signal 255 for controlling the drive device 205 and/or a brake signal for controlling the brake device 210. An operating voltage for operating the drive device 205 can be provided to the drive device 205 through the drive signal 255. The drive signal 255 is configured, e.g., to activate the drive device 205 in response to an opening and/or closing movement of the door 110 that is to be carried out. An operating current for the actuator 220 can be provided or controlled through the brake signal 260. By way of example, an operating current can be provided to the actuator 220 in response to an opening and/or closing movement of the door 110 that is to be carried out, in order to reduce the braking effect of the magnetorheological material 215.

According to one exemplary embodiment, the door moving device 115 has a sensor device 265 that is configured to detect a closing angle and/or a torque in the movement of the door 110. Furthermore, the door moving device 115 may have an optional environment sensor device, which is configured to detect an obstacle in a movement range of the door 110. A sensor signal from the sensor device 265 is used by the regulating device 250 to provide the drive signal 255 and/or the braking signal 260 according to one exemplary embodiment.

The door moving device 115 comprises a housing 270, which encompasses the force providing device 200, the drive device 205, and the brake device 210. The free end 240 of the shaft 225 is located outside the housing 270. For this, the shaft 225 extends through a hole in a wall of the housing 270 that is provided with a bearing 275.

Exemplary embodiments of the approach shall be explained again, more precisely, below:

The door moving device 115 presented herein is an electromechanical system that supports the operation of at least one vehicle door.

In differing from known hydraulic door operators, the door moving device 115 represents a simple system, which enables a simple, definable behavior of the door 110 that is to be operated when it is not supplied with electricity, at low costs. In differing from the known, purely motorized door operators, the door moving device 115 also requires little installation space, and very little or no electricity, advantageously, if the door 110 is held in a stationary position for a long time. A high power density of the brake actuator in the form of the actuator 220 results in a small installation space.

The door moving device 115 can also be referred to as an optimized actuator, which enables a retention force applied to a door 110 to be adjusted in a defined manner when this retention force is obtained without electricity. An advantage of the door moving device 115 is an overall lower power consumption. The smaller installation space allows it to be installed in a limited hinge region of the door 110. An acoustic behavior is also optimized, because it is possible to reproduce the catches for the door with software for variable door operation. The door moving device 115 also enables a braking if there are obstacles in the door pivoting range, a securing of the door 110 in place to serve as an aid in entering or exiting the vehicle, and an automatic closing of the door 110. Furthermore, the speed of opening and closing the door can be limited and defined when the vehicle is parked on an incline.

The door moving device 115 can also be referred to as an intelligent actuator with an electronics system, which contains an electrical actuator in the form of a drive device 205 and a brake in the form of the brake device 210. The actuator and brake are controlled by the same regulating device 250. A main function of the drive device 205 is the active movement of the door 110, i.e. an opening and/or closing of the door 110. The installed brake device 210 also generates a high braking torque when it is not supplied with electricity. An electric motor cannot generate the high stationary torque of a brake. However, a brake cannot actively move a door 110. The brake device 210 can generate much higher braking torques than a motor with the same structural size and same energy consumption. An important feature is also the braking function without electricity, e.g. for when the door 110 is kept open for longer periods of time. The door moving device 115 therefore comprises a collective module comprising, once again, the drive device 205, also referred to as a DC motor, the electrically actuated brake device 220 that has a braking function when it is not supplied with electricity obtained through a magnetorheological braking actuator and an associated electronic control, i.e. the regulating device 250, which has a superimposed regulation of the drive device 205 and the brake device 210. The low power consumption takes place in particular when the door 110 is to be held in an open position for a long time.

According to this exemplary embodiment, the sensor device 265 for detecting the closing angle and torque when operating the door is integrated in the door moving device 115. The shaft 225 is located with the gearwheel 245 at an outlet in the door moving device 115. The hinge strap 120 has a toothing for the door moving device 115. This also comprises an overall system for automatically opening and/or closing the door 110. This requires the environment sensor device for evaluating an opening range of the door 110 with regard to obstacles. The environment sensor device comprises at least a 2D camera and/or a 3D camera, and/or a light barrier device, and/or a 3D scanner for this, according to this exemplary embodiment. It is also possible to pull the door 110 closed from a retained position to final closed position with regard to a lock, wherein this procedure is also referred to as a “soft close.”

FIG. 3 shows a flow chart for a method 300 for moving a door according to an exemplary embodiment. This can be a method 300 that can be executed by the door moving devices described in reference to FIGS. 1 and 2.

The method 300 comprises at least one step 305 for generating a drive torque and one step 310 for generating a braking torque.

In step 305, for generating a drive torque, a drive torque is generated for driving a force providing device for providing a force for controlling the movement of the door.

In step 310, for generating a braking torque, a braking torque for braking the force providing device is generated by an electrically actuated brake device when the brake device is not supplied with electricity.

If an exemplary embodiment comprises an “and/or” conjunction between a first feature and a second feature, this can be read to mean that the exemplary embodiment according to one embodiment comprises both the first feature and the second feature, and comprises either just the first feature or just the second feature according to another embodiment.

### LIST OF REFERENCE SYMBOLS

100 vehicle
105 door system
110 door
115 door moving device
120 hinge strap
200 force providing device
205 drive device
210 brake device
215 magnetorheological material
220 actuator
225 shaft
230 gear ratio device
235 gear ratio element
240 free end
245 gearwheel
250 regulating device
255 drive signal
260 brake signal
265 sensor device
270 housing
275 bearing
300 method
305 step for generating a drive torque
310 step for generating a braking torque

1. A door moving device for a door, wherein the door moving device comprises:
a force providing device for providing a force for controlling a movement of the door;
a drive device that is configured to generate a drive torque for powering the force providing device; and
an electrically actuated brake device that is configured to generate a braking torque for braking the force providing device when not supplied with electricity.

2. The door moving device according to claim 1, in which the brake device comprises at least a magnetorheological material and an actuator for adjusting a viscoelastic property of the magnetorheological material.

3. The door moving device of claim 1, wherein the brake device is configured to generate a first braking torque when not supplied with electricity, and a second braking torque, which is lower than the first braking torque, when the brake device is supplied with electricity.

4. The door moving device of claim 1, which has a regulating device that is configured to output a drive signal for controlling the drive device and/or a brake signal for controlling the brake device.

5. The door moving device of claim 1, wherein the drive device comprises an electric motor.

6. The door moving device of claim 1, wherein the force providing device comprises a shaft that is coupled to the brake device.

7. The door moving device of claim 1, further comprising a gear ratio device that couples the drive device with the force providing device.

8. The door moving device of claim 1, wherein the force providing device comprises a gearwheel at one end for applying the force to the door.

9. The door moving device of claim 1, wherein the force providing device comprises an element of a hinge for the door.

10. The door moving device of claim 1, further comprising a sensor device that is configured to detect a closing angle and/or a torque in the movement of the door.

11. The door moving device of claim 1, further comprising an environment sensor device that is configured to detect an obstacle in a movement range of the door.

12. A door system that has a door and a door moving device of claim 1, wherein the force providing device of the door moving device is coupled to the door.

13. A method for moving a door, wherein the method comprises:
generating a drive torque for driving a force providing device for providing a force for controlling the movement of the door; and
generating a braking torque for braking the force providing device using an electrically actuated brake device, wherein the brake device generates the tracking torque when not provided with electricity.
